(19) United States
(12) Patent Application Publication
(10) Pub. No.: US 2014/0360389 A1
(43) Pub. Date: Dec. 11, 2014

(54) FRAME FOR ACCOMMODATING VARYING PRINTING PRESS GRIPPER MARGINS

(71) Applicants: Thomas P. Driscoll, Chicago, IL (US); Ronald A. Jenkins, Bourbonnais, IL (US); Bradley C. Owen, Prospect Heights, IL (US)

(72) Inventors: Thomas P. Driscoll, Chicago, IL (US); Ronald A. Jenkins, Bourbonnais, IL (US); Bradley C. Owen, Prospect Heights, IL (US)

(21) Appl. No.: 13/910,943

(22) Filed: Jun. 5, 2013

(51) Int. Cl. B41F 19/00

(52) U.S. Cl. CPC B41F 19/008
USPC 101/28

(57) ABSTRACT

A frame assembly for retaining a tool for use in a press having a gripper margin that is larger than the gripper margin of the tool. The assembly includes a frame member having a lower wall including an opening, back wall and upper wall defining a rectangular channel. Also include is a rectangular spacer adapted to fit within said channel and sized to increase the effective length of the tool to match the gripper margin of the tool with the gripper margin of the press. The assembly further includes an extension on said spacer located to engage an opening in the lower wall.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

The present invention concerns a frame for holding a stripping tool or blank separating tool for perforating, punching, cutting-out or stamping-out previously perforated material. The frame includes a removable spacer that permits a single tool to be used in cutting presses requiring different gripper margins without modifying the tool.

2. Description of Related Art

In cutting presses, cutting, stripping and blanking tools are used to work the material, usually paper stock, to impart, remove or form patterns, cutouts and scoring. The paper stock used in this process is normally first worked by a printing press to impart some graphical image or outline of the items to be worked. As the speed of a printing press increases, the information required by the printing press to manage the operation increases accordingly. To provide real-time processing information to the printing press, the paper stock often includes informational bar codes and the like. The area of the paper stock in which this processing information is located usually precedes the area to be worked and is essentially an area that will be discarded. It is a waste area and is often referred to as the “gripper margin.” A secondary necessity of this gripper margin is for use as a clamping zone by the print press or cutting press for pulling the paper stock through the machine.

Since the tools for the cutting press are typically made of a solid material such as wood, and rectangular in shape, the dimensions and lineup of the tools are typically constructed for a predetermined gripper margin. Typically the length or depth of the tool correlates to the gripper margin. Thus, if the gripper margin increases, the length or depth of the tool needs to increase accordingly. Conversely, a decrease in the gripper margin requires decreasing the length or depth of the tool.

Generally, if an operator is using a paper stock from a printing press that has the same gripper margin as the cutting press for which the tools were designed, no difficulties arise as to the interchangeability of the tools that may be used. As an operator's processing needs change, tools may be interchanged without difficulty since all previously manufactured tools fit a common standard for the printing and cutting machinery being used. However, interchangeability difficulties arise when operators begin implementing higher speed printing presses requiring the use of larger gripper margins. Any previous tool built for the smaller gripper margin becomes incompatible with a cutting press now requiring a larger gripper margin tool. To accommodate an increase in gripper margin, the length or depth of the tool needs to be modified to match the new gripper margin.

To increase the gripper margin of a tool, the tool may be adapted by adding a compensation gib to the front edge of the tool. This requires drilling holes in the wooden tools and securing the gib with threaded fasteners.

Adapting a tool with a gib is undesirable for several reasons. First, it is time consuming and expensive to retrieve a tool, drill holes in it, and then fasten gibs to the edge of the tool. The expense of adapting an entire inventory of tools is dramatic when it is considered that operators often use hundreds of tools in a single facility.

Another drawback is that once a tool is adapted, the gib needs to be removed in order to use the tool in the event that the paper stock for the job is moved to a printing press with the original smaller gripper margin. Since operators potentially run multiple gripper margin printing presses in a single plant, there is a need for a solution that allows the tools to be used interchangeably between cutting presses utilizing paper stock with different grippers margins in a cost-effective manner.

### BRIEF SUMMARY OF THE INVENTION

The present invention provides a solution to the above problems. It deploys a removable spacer that provides the necessary additional length or depth to the tool to permit use with an increased gripper margin. The spacer is releasably attached to the frame to form an assembly that holds the leading edge of the tool. Modifying the frame rather than the tool avoids the need to modify each tool used with the press.

### BRIEF DESCRIPTION OF THE SEVERAL VIEWS OF THE DRAWINGS

FIG. 1 shows a tool loaded into a frame of the press.

FIG. 2 is a partial exploded side perspective view of the tool and frame shown in FIG. 1.

FIG. 3 is a top view illustrating a first gripper margin on a work piece.

FIG. 4 is a top view of a tool sized to accommodate a first gripper margin.

FIG. 5 is a partial side view of the tool shown in FIG. 4 secured within a frame at a first gripper margin.

FIG. 6 is a top view illustrating a second, larger gripper margin on a work piece.

FIG. 7 is a top view of a tool sized to accommodate a second, larger gripper margin.

FIG. 8 illustrates adapting a tool with a gib to accommodate an increase in gripper margin.

FIG. 9 is an exploded perspective view of one embodiment of the present invention.

FIG. 10 is a partial side view of the embodiment shown in FIG. 9 showing a spacer located in the frame to accommodate at a second gripper margin that is larger than the first gripper margin.

FIG. 11 is a front view of a frame or bracket used with the embodiment shown in FIG. 9.

FIG. 12 is an exploded perspective view of another embodiment of the present invention.

FIG. 13 is a front view of a frame or bracket used with the embodiment shown in FIG. 12.

FIG. 14 is an exploded perspective view of another embodiment of the present invention.

FIG. 15 is a front view of a frame or bracket used with the embodiment shown in FIG. 14.

FIG. 16 is an exploded perspective view of another embodiment of the present invention.

FIG. 17 is an exploded perspective view of another embodiment of the present invention.

FIG. 18 is a front view of a frame or bracket used with the embodiment shown in FIG. 17.

FIG. 19 is an exploded perspective view of another embodiment of the present invention.

FIG. 20 is a front view of a frame or bracket used with the embodiment shown in FIG. 19.

FIG. 21 is an exploded perspective view of another embodiment of the present invention.

### DETAILED DESCRIPTION OF THE INVENTION

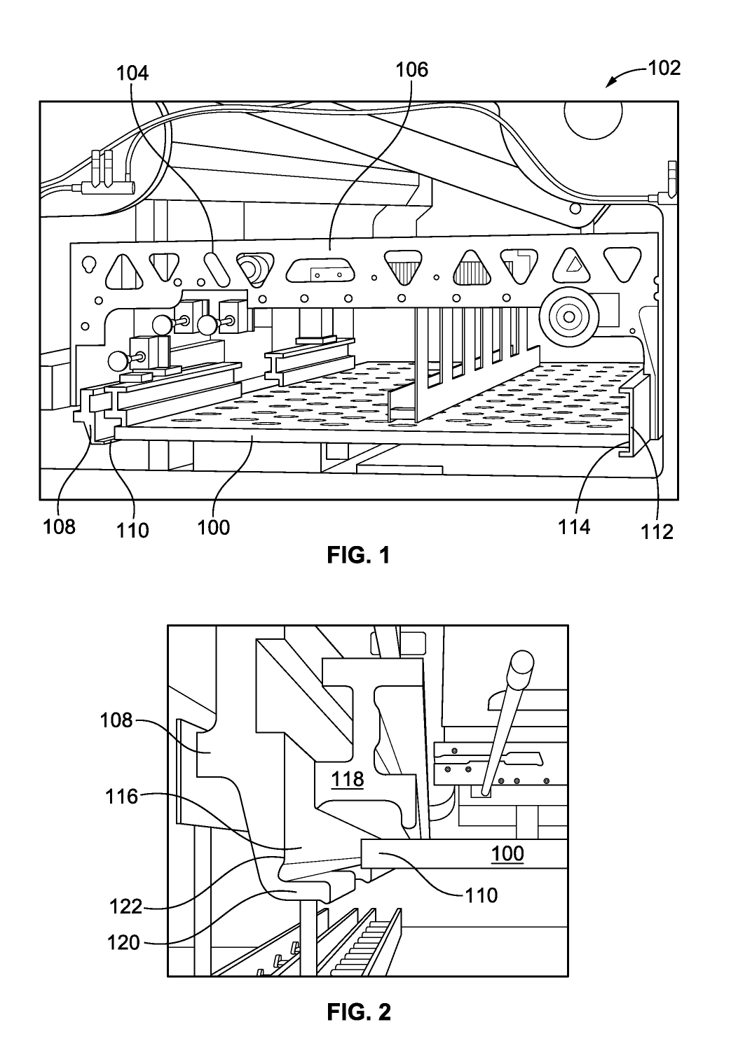

FIG. 1 shows a converting tool 100 for use in a press 102. Tool 100 may be an upper stripping tool, an upper blanking separating tool, or a similar tool to be used in shaping a work piece. Tool 100 is secured within the press by a frame-assembly 104 having a cross member 106, a first section or bracket 108 adapted to secure the leading edge 110 of tool 100, and a second bracket or section 112 adapted to secure the trailing edge 114 of tool 100.

FIG. 2 illustrates how bracket 108 secures leading edge 110 of tool 100. Bracket 108 includes a generally U-shaped channel 116 defined by an upper wall 118, a lower wall 120, and a back wall 122. Tensioning the brackets 108 and 112 inwardly compresses tool 100 into a locked position as shown in FIG. 1.

To change a tool within assembly, a locking mechanism (not shown) that secures the tool and centers it, is released. The tool is then slid out of the frame-assembly and a new tool is inserted.

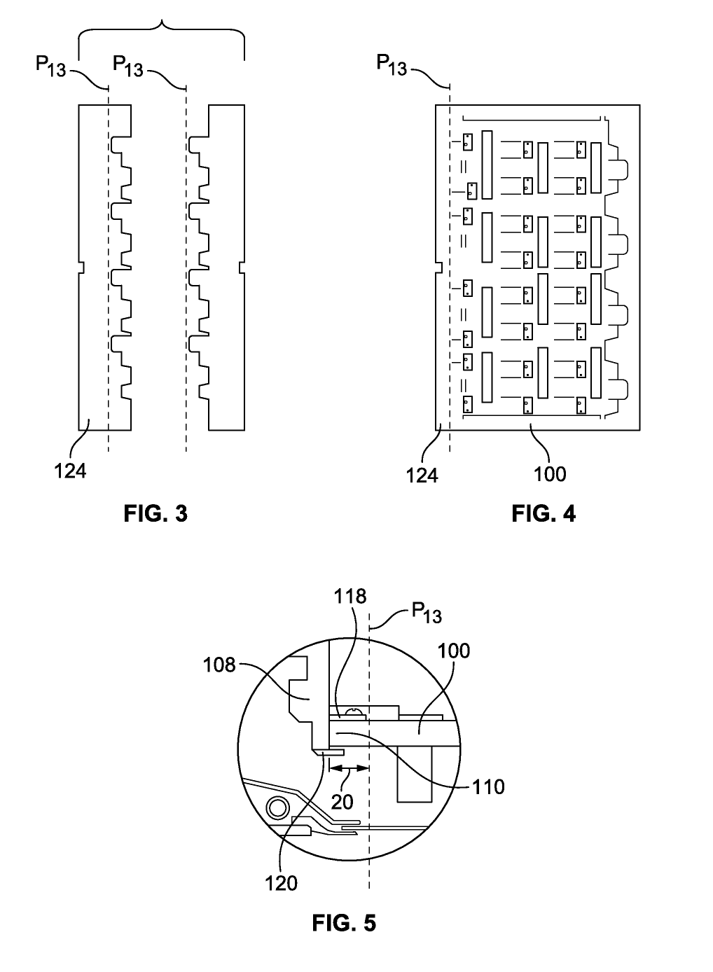

FIG. 3 is top view of a work piece having a waste area of a dimension P13 representing a gripper margin 124. FIG. 4 illustrates how tool 100 has a length or depth sized to conform to gripper margin 124.

FIG. 5 illustrates a tool seated within bracket 108.

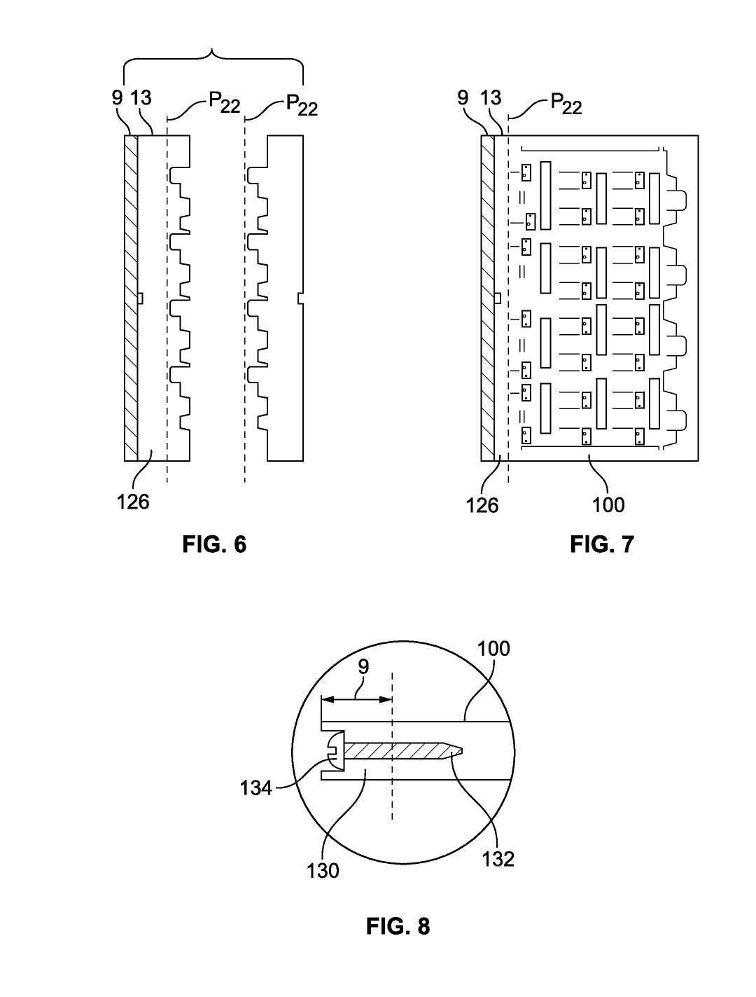

As set forth above, gripper margins may increase to accommodate the needs of a press. This increase is illustrated in FIG. 6. As shown, gripper margin 126 has increased by 9 units from P13 to P22. As mentioned above, this requires tool 100 to accordingly increase in overall effective length or depth by 9 units as illustrated in FIG. 7.

To change the length of tool 100, as shown in FIG. 8, a gib 130 which is 9 units in length or depth may be attached to the tool by creating a hole 132 and using a threaded fastener 134. Adapting tooling with gibs is undesirable. It is time-consuming, expensive and requires the removal of the gibs to use the tool in a press requiring a smaller gripper margin.

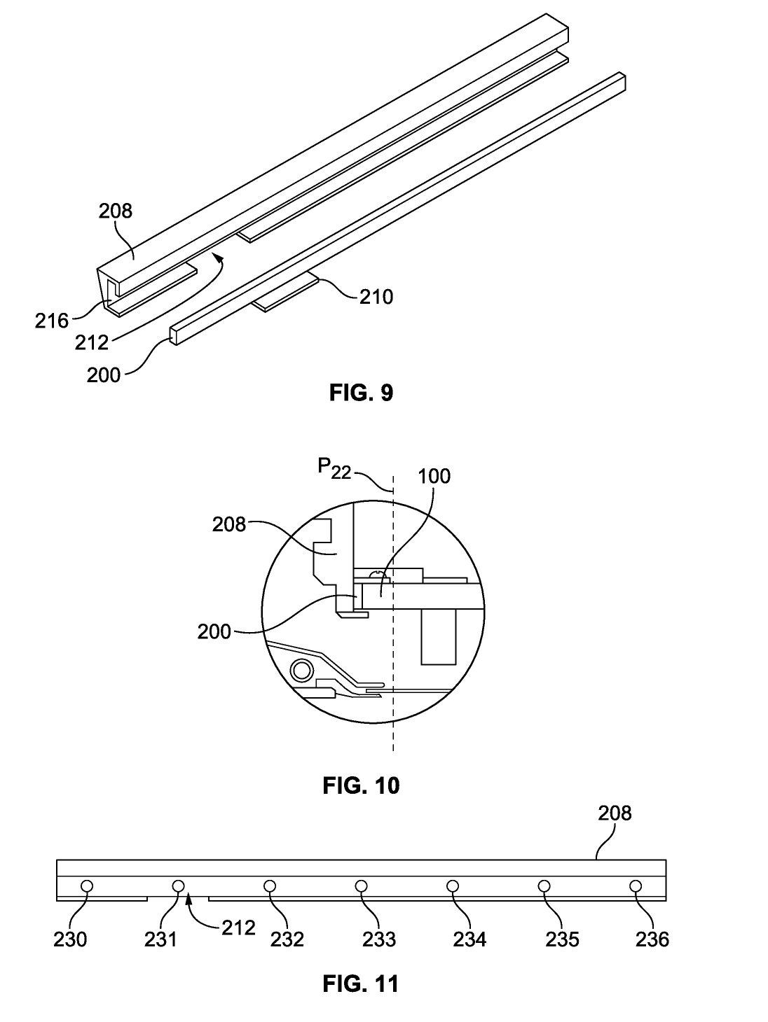

As shown in FIGS. 9 and 10, in one embodiment of the present invention, a spacer 200 is used in connection with a frame, section or bracket 208 to form a frame or bracket assembly that avoids the need to modify tool 100. Spacer 200 is dimensioned to have a length or depth that matches the change in gripper margin. Spacer 200 is also dimensioned to match the general overall dimensions of channel 216 and is preferably in the shape of an elongated rectangle.

Inserting spacer 200 into channel 216 locates it between tool 100 and frame 208 as shown in FIG. 10. This adds the necessary additional dimensional length or depth to the tool to accommodate the increased gripper margin as shown in FIG. 10. This method avoids the need to retrofit tools constructed for the smaller gripper margin. That spacer 200 is removable also allows the press to be used with tools specifically designed for it as well as with tooling built for smaller gripper margins.

To positively secure spacer 200 within the bracket or frame to prevent it from “walking out” of the open-sided bracket or frame, a tab or extension 210 may be added. Tab 210 is sized and located to fit within and engage a complimentary shaped opening or pocket 212 in frame 208.

As shown in FIG. 11, a plurality of magnets 230-236 may be located in bracket or frame 208. The magnets assist in the insertion of spacer 200 into channel 216 by holding it against the inner wall of channel 216 while allowing the spacer to be easily released for removal. Alternately, a magnetized spacer may be used so long as metal inserts 240-246 are located in frame 208 as shown in FIG. 13.

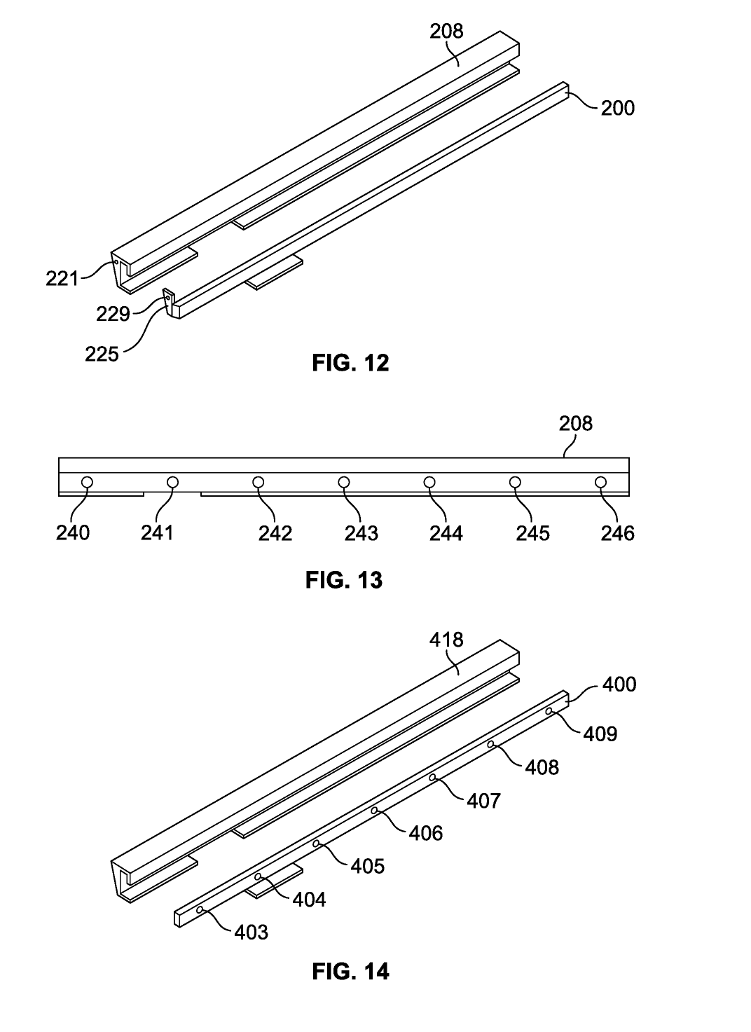

As FIG. 12 further illustrates, spacer 200 may also include a flange 225 with a borehole 229 that aligns with borehole 221 on the side of frame 208 to receive a fastener that additionally secures the spacer to the frame.

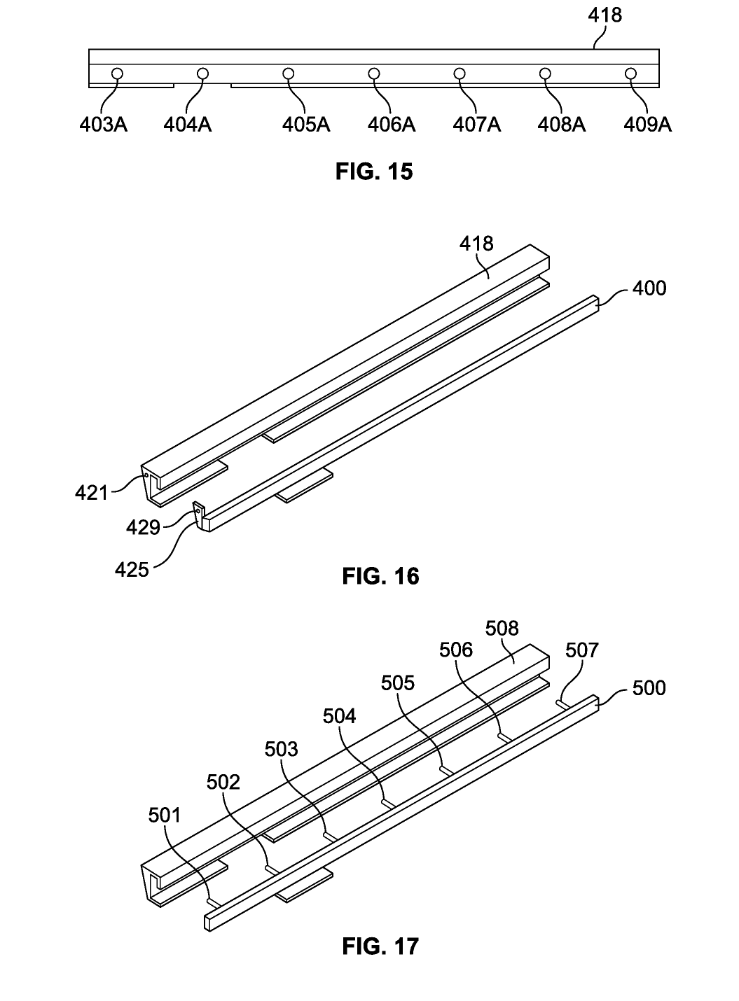

In addition, boreholes 403-409 may be located in spacer 400 and aligned with boreholes 403A-409A located in channel wall 416 of bracket or frame 418 as shown in FIGS. 14 and 15. Fasteners may then be used to affix spacer 400 to frame 418.

FIG. 16 further illustrates that the embodiment shown in FIG. 14 may include a flange 425 with a borehole 429 that aligns with borehole 421 to receive a fastener that additionally secures the spacer to the frame.

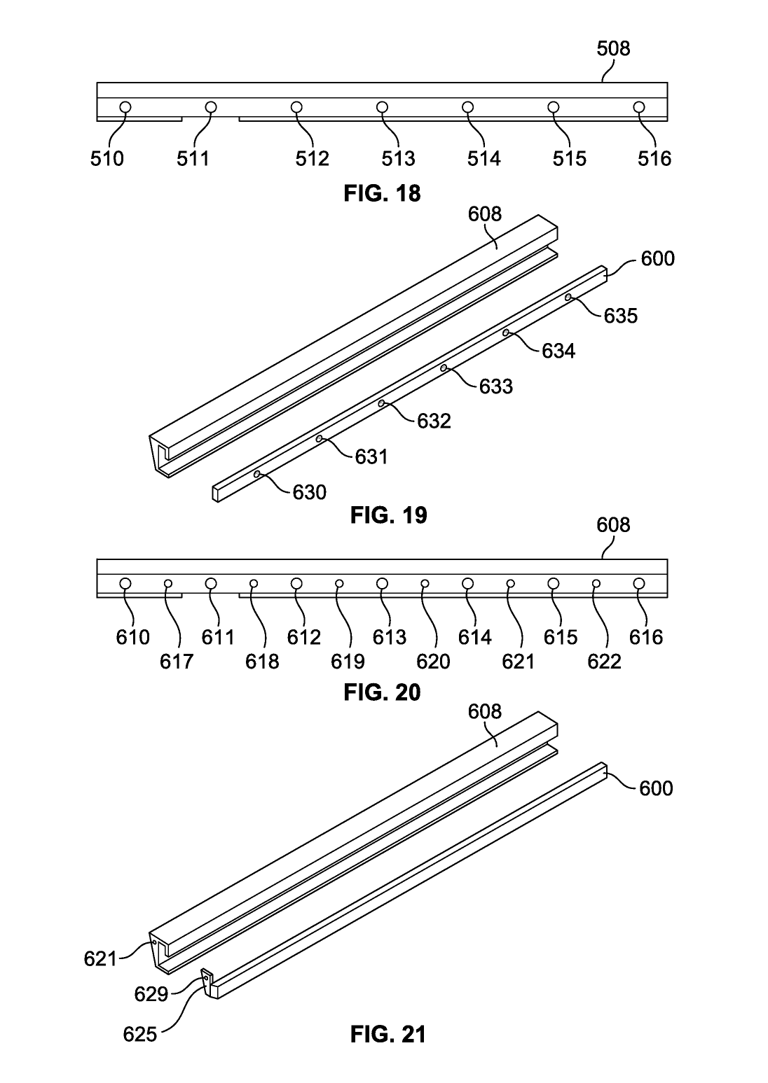

FIGS. 17 and 18 illustrate yet another embodiment of the present invention. As shown, additional lateral retention is achieved by locating studs 501-507 on spacer 500. The studs align with holes 510-516 located in bracket or frame 508. In use, the studs are inserted into the holes to provide positive retention.

FIGS. 19 and 20 illustrate yet another embodiment of the present invention. As shown, additional lateral retention is achieved by using magnets 610-616 and dimples 617-622 located in frame 608. The dimples are positioned to correlate with and interlock with bumps 630-635 on spacer 600.

FIG. 21 further illustrates that the embodiment shown in FIGS. 19 and 20 may include a flange 625 with a borehole 629 that aligns with borehole 621 to receive a fastener that additionally secures the spacer to the frame.

What is claimed is:

1. An assembly for retaining a tool for use in a press having a gripper margin that is larger than the gripper margin of the tool comprising:
a frame having a first, second and third wall, said walls defining a channel; and
a spacer adapted to fit within said channel and sized to increase the effective length of the tool to match the gripper margin of the tool with the gripper margin of the press.

2. The assembly of claim 1 wherein said spacer is includes an extension and said frame includes an opening adapted to engage said extension.

3. The assembly of claim 1 wherein said spacer is releasably retained within said channel.

4. The assembly of claim 3 wherein said spacer is releasably retained within said channel by a plurality of magnets located in said frame.

5. The assembly of claim 3 wherein said spacer is magnetic and is releasably retained within said channel.

6. The assembly of claim 1 wherein said spacer includes a plurality of projections adapted to fit within openings in said frame to releasably retain said spacer within said channel.

7. The assembly of claim 1 wherein said spacer includes a plurality of opening and a plurality of fasteners to affix said spacer to said frame.

8. The assembly of claim 1 wherein said spacer includes a plurality of dimples adapted to fit within openings in said frame to releasably retain said spacer within said channel.

9. An assembly for retaining a tool for use in a press having a gripper margin that is larger than the gripper margin of the tool comprising:
a frame having a first wall including an opening, a second wall and third wall, said walls defining a rectangular channel;
a rectangular-shaped spacer adapted to fit within said channel and sized to increase the effective length of the tool to match the gripper margin of the tool with the gripper margin of the press; and
an extension on said spacer located to engage an said opening in said frame.

10. The assembly of claim 9 wherein said spacer is releasably retained within said channel.

11. The assembly of claim 10 wherein said spacer is releasably retained within said channel by a plurality of magnets located in said frame.

12. The assembly of claim 10 wherein said spacer is magnetic and is releasably retained within said frame.

13. The assembly of claim 9 wherein said spacer includes a plurality of projections adapted to fit within openings in said frame to releasably retain said spacer within said channel.

14. The assembly of claim 9 wherein said spacer includes a plurality of opening and a plurality of fasteners to affix said spacer to said frame.

15. The assembly of claim 9 wherein said spacer includes a plurality of dimples adapted to engage openings in said frame to releasably retain said spacer within said channel.

16. An assembly for retaining a tool for use in a press having a gripper margin that is larger than the gripper margin of the tool comprising:
a frame having a lower wall including a first, second and third wall, said walls defining a rectangular channel;
a rectangular-shaped spacer adapted to fit within said channel and sized to increase the effective length of the tool to match the gripper margin of the tool with the gripper margin of the press;
an extension on said spacer located to engage an said opening in said frame; and
a plurality of magnets located in said frame to releasably retain said spacer held within said channel.

17. The assembly of claim 16 wherein said spacer includes a flange with an aperture located to cover a threaded bore on said frame, and a fastener for securing said spacer to said frame by engaging said threaded bore.

18. The assembly of claim 1 wherein said spacer includes a flange with an aperture located to cover a threaded bore on said frame, and a fastener for securing said spacer to said frame by engaging said threaded bore.

19. The assembly of claim 9 wherein said spacer includes a flange with an aperture located to cover a threaded bore on said frame, and a fastener for securing said spacer to said frame by engaging said threaded bore.
